(19) United States
(12) Patent Application Publication
(10) Pub. No.: US 2014/0101072 A1
(43) Pub. Date: Apr. 10, 2014

(54) SYSTEM AND METHOD FOR DISPLAYING A GIVING PLAN

(71) Applicant: BANK OF AMERICA CORPORATION, Charlotte, NC (US)

(72) Inventors: Matthew A. Calman, Charlotte, NC (US); Carrie Anne Hanson, Charlotte, NC (US); Scott R. Enscoe, Waxhaw, NC (US); John Rees, Charlotte, NC (US); Nancy Talarico, Matthews, NC (US); Sven David Newman, Burlingame, CA (US); Greg Leonard Hertz, San Francisco, CA (US)

(73) Assignee: Bank of America Corporation, Charlotte, NC (US)

(21) Appl. No.: 13/647,769

(22) Filed: Oct. 9, 2012

(51) Int. Cl. G06Q 40/06

(52) U.S. Cl. 705/36 R

(57) ABSTRACT

According to some embodiments, a system comprises an interface and one or more processors. The interface receives a request to display a giving plan associated with a donor. The processors determine beneficiaries and assets of the donor. The processors also determine an allocation plan that associates one or more of the assets with one or more of the beneficiaries. The interface displays the giving plan comprising a graphical representation of the beneficiaries and a relative value of the assets associated with each beneficiary based on the allocation plan. The giving plan also comprises interactive features that facilitate modifying the graphical representation in order to visualize a potential change to the allocation plan.

### TECHNICAL FIELD OF THE INVENTION

The present invention relates generally to planning an asset transfer and more specifically to a system and method for displaying a giving plan.

### BACKGROUND OF THE INVENTION

A donor may own assets, such as property or money, that the donor wishes to transfer to one or more relatives, friends, charities, and/or other beneficiaries. Transfers may be made according to a will, a trust, or a living gift. A will is written and signed by the donor, and it states how to divide and transfer the assets upon the donor's death. A trust allows for transferring assets to beneficiaries indirectly through a trustee. The trustee distributes the assets to the beneficiaries based on the terms of a trust document written by the donor. A living gift may be a gift made from the donor to the beneficiary during the lifetime of the donor.

### SUMMARY OF THE INVENTION

According to some embodiments, a system comprises an interface and one or more processors. The interface receives a request to display a giving plan associated with a donor. The processors determine beneficiaries and assets of the donor. The processors also determine an allocation plan that associates one or more of the assets with one or more of the beneficiaries. The interface displays the giving plan comprising a graphical representation of the beneficiaries and a relative value of the assets associated with each beneficiary based on the allocation plan. The giving plan also comprises interactive features that facilitate modifying the graphical representation in order to visualize a potential change to the allocation plan.

Certain embodiments of the invention may provide one or more technical advantages. In some embodiment, a giving plan may be displayed graphically to help a donor make decisions about how to allocate assets among the donor's beneficiaries. The graphical display may include interactive features to engage the donor and allow the donor to compare a variety of giving options. In some embodiments, the graphical display may provide a relatively inexpensive and efficient self-service estate planning tool that allows the donor to plan gifts with less reliance on advisors.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example of a system for displaying a giving plan.

FIGS. 2A-2C illustrate an example of a display for displaying a giving plan; and

FIG. 3 illustrates an example of a method for displaying a giving plan.

### DETAILED DESCRIPTION OF THE INVENTION

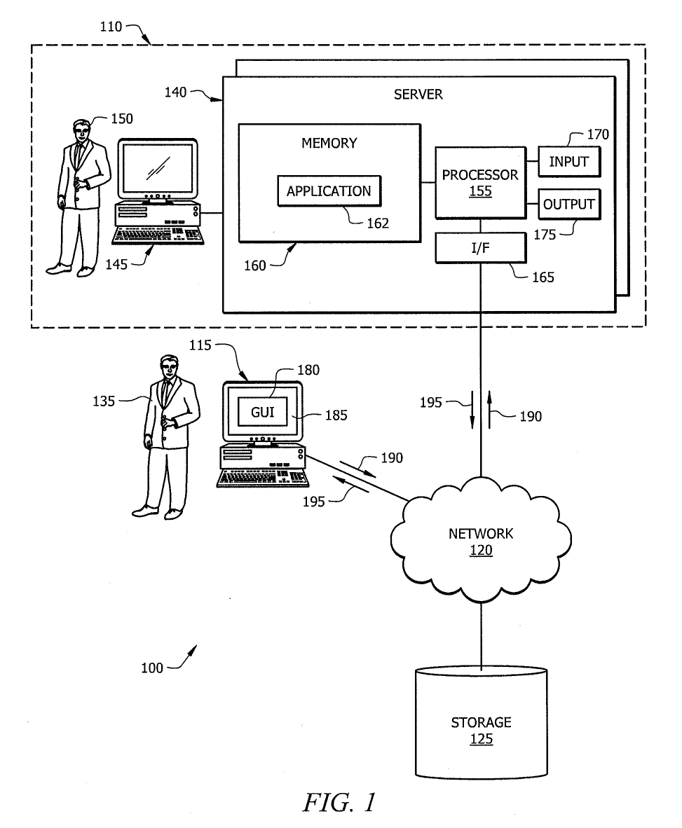

Embodiments of the present invention and its advantages are best understood by referring to FIGS. 1 through 3 of the drawings, like numerals being used for like and corresponding parts of the various drawings.

A donor may own assets, such as property or money, that the donor wishes to transfer to one or more relatives, friends, charities, and/or other beneficiaries. Transfers may be made according to a will, a trust, or a living gift. A will is written and signed by the donor, and it states how to divide and transfer the assets upon the donor's death. A trust allows for transferring assets to beneficiaries indirectly through a trustee. The trustee distributes the assets to the beneficiaries based on the terms of a trust document written by the donor. A living gift may be a gift made from the donor to the beneficiary during the lifetime of the donor. Making decisions about how to distribute the assets may be complex. For example, the donor may wish to divide assets in a balanced manner based on considerations such as the type of asset, the needs of the beneficiary, and the relationship of the beneficiary to the donor. Embodiments of the present disclosure assist the donor in making these decisions by displaying a giving plan to the donor, as discussed with respect to FIGS. 1 through 3 below.

FIG. 1 illustrates a system 100 according to certain embodiments. System 100 may include enterprise 110, one or more clients 115, a network storage device 125, one or more servers 140, and one or more donors 135. Enterprise 110, clients 115, and network storage device 125 may be communicatively coupled by a network 120. System 100 may facilitate displaying a giving plan that allows donor 135 to view and modify a distribution of donor 135's assets among beneficiaries of donor 135.

In general, donor 135 utilizes client 115 to interact with server 140 to request to display or configure a giving plan. For example, donor 135 provides a request 190 to server 140 utilizing client 115. In some embodiments, request 190 includes a user identifier associated with donor 135, such as a login name for an online account. Request 190 may also include information describing the requested transaction. For example, request 190 may request to configure a list of beneficiaries of donor 135, a list of assets of donor 135, or an allocation plan for allocating donor 135's assets to the beneficiaries. Or request 190 may request to display a giving plan based on the beneficiaries, assets, and/or allocation plan configured by donor 135.

Client 115 may refer to any device that enables donor 135 to interact with server 140. In some embodiments, client 115 may include a computer, workstation, telephone, Internet browser, electronic notebook, Personal Digital Assistant (PDA), pager, Automatic Teller Machine (ATM) or any other suitable device (wireless, wireline, or otherwise), component, or element capable of receiving, processing, storing, and/or communicating information with other components of system 100. Client 115 may also comprise any suitable user interface such as a display 185, microphone, keyboard, credit card reader, check reader, or any other appropriate terminal equipment usable by a donor 135. It will be understood that system 100 may comprise any number and combination of clients 115.

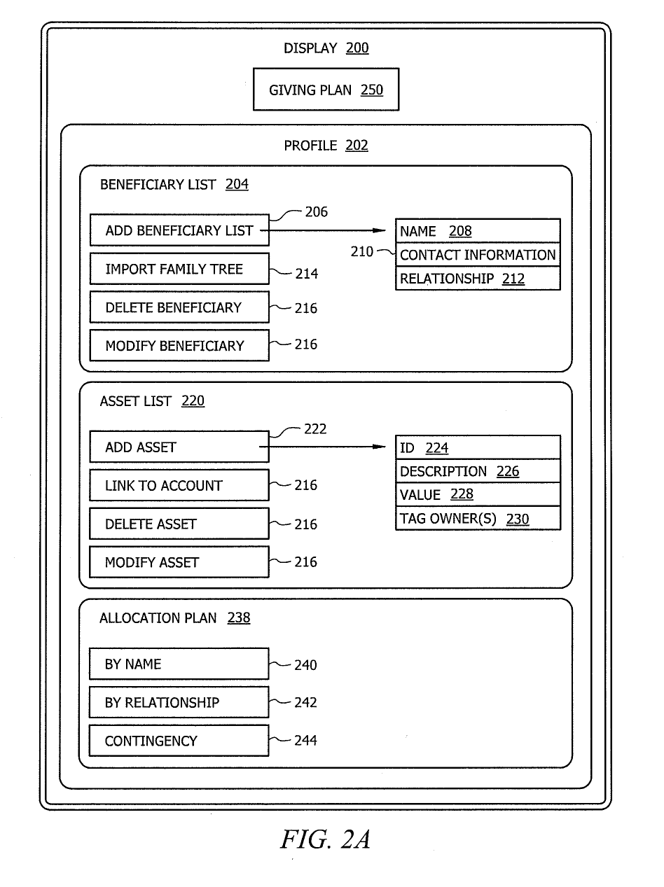

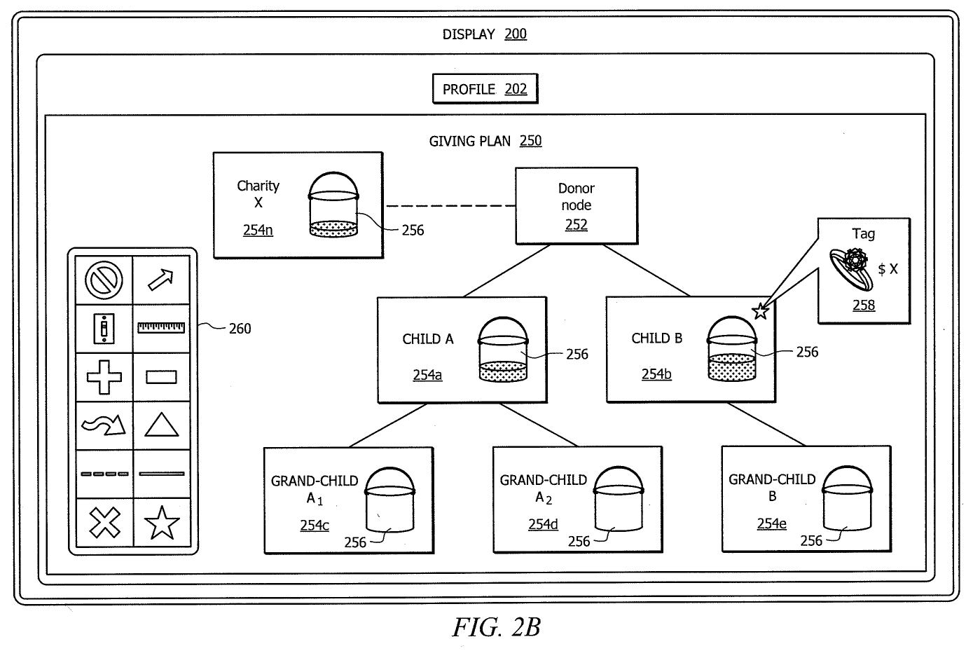

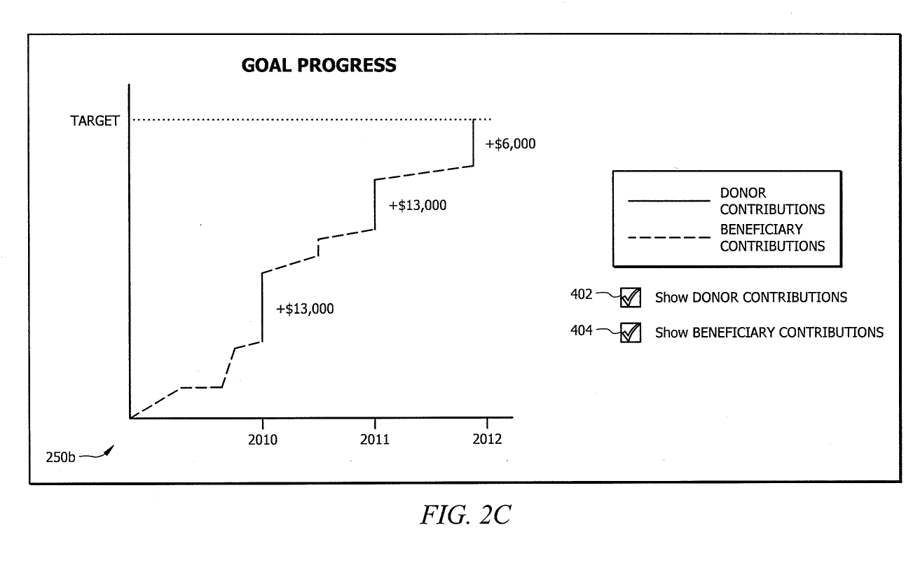

In some embodiments, client 115 may include a graphical user interface (GUI) 180. GUI 180 is generally operable to tailor and filter data entered by and presented to donor 135. GUI 180 may provide donor 135 with an efficient and user-friendly presentation of request 190 and/or response 195. GUI 180 may comprise a plurality of displays having interactive fields, pull-down lists, and buttons operated by donor 135. GUI 180 may include multiple levels of abstraction including groupings and boundaries. It should be understood that the term GUI 180 may be used in the singular or in the plural to describe one or more GUIs 180 and each of the displays of a particular GUI 180. In some embodiments, GUI 180 may display the giving plan described with respect to FIGS. 2A-2B below.

In some embodiments, network storage device 125 may refer to any suitable device communicatively coupled to network 120 and capable of storing and facilitating retrieval of data and/or instructions. Examples of network storage device 125 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Network storage device 125 may store any data and/or instructions utilized by server 140. FIG. 2A below describes an example of a profile that may be stored by network storage device 125.

In certain embodiments, network 120 may refer to any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, enterprise 110 may refer to a financial institution such as a bank and may include one or more servers 140, an operator workstation 145, and an operator 150. In some embodiments, server 140 may refer to any suitable combination of hardware and/or software implemented in one or more modules to process data and provide the described functions and operations. In some embodiments, the functions and operations described herein may be performed by a pool of servers 140. In some embodiments, server 140 may include, for example, a mainframe, server, host computer, workstation, web server, file server, a personal computer such as a laptop, or any other suitable device operable to process data. In some embodiments, server 140 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems.

In some embodiments, servers 140 may include a processor 155, server memory 160, an interface 165, an input 170, and an output 175. Server memory 160 may refer to any suitable device capable of storing and facilitating retrieval of data and/or instructions. Examples of server memory 160 include computer memory (for example, RAM or ROM), mass storage media (for example, a hard disk), removable storage media (for example, a CD or a DVD), database and/or network storage (for example, a server), and/or or any other volatile or non-volatile, non-transitory computer-readable memory devices that store one or more files, lists, tables, or other arrangements of information. Although FIG. 1 illustrates server memory 160 as internal to server 140, it should be understood that server memory 160 may be internal or external to server 140, depending on particular implementations. Also, server memory 160 may be separate from or integral to other memory devices to achieve any suitable arrangement of memory devices for use in system 100.

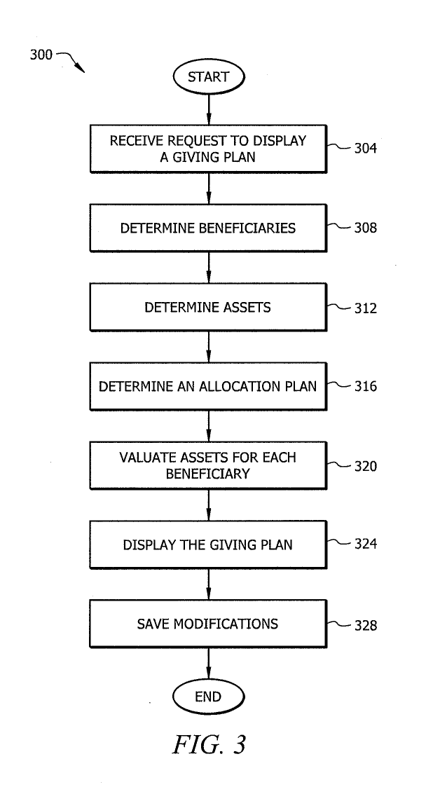

Server memory 160 is generally operable to store an application 162. Application 162 generally refers to logic, rules, algorithms, code, tables, and/or other suitable instructions for performing the described functions and operations. In some embodiments, application 162 facilitates configuring and displaying a giving plan, as discussed in more detail with respect to FIGS. 2A, 2B, and 3 below.

Server memory 160 communicatively couples to processor 155. Processor 155 is generally operable to execute application 162 stored in server memory 160 to display the giving plan according to the disclosure. Processor 155 may comprise any suitable combination of hardware and software implemented in one or more modules to execute instructions and manipulate data to perform the described functions for servers 140. In some embodiments, processor 155 may include, for example, one or more computers, one or more central processing units (CPUs), one or more microprocessors, one or more applications, and/or other logic.

In some embodiments, communication interface 165 (I/F) is communicatively coupled to processor 155 and may refer to any suitable device operable to receive input for server 140, send output from server 140, perform suitable processing of the input or output or both, communicate to other devices, or any combination of the preceding. Communication interface 165 may include appropriate hardware (e.g., modem, network interface card, etc.) and software, including protocol conversion and data processing capabilities, to communicate through network 120 or other communication system, which allows server 140 to communicate to other devices. Communication interface 165 may include any suitable software operable to access data from various devices such as clients 115 and/or network storage device 125. Communication interface 165 may also include any suitable software operable to transmit data to various devices such as clients 115 and/or network storage device 125. Communication interface 165 may include one or more ports, conversion software, or both. In general, communication interface 165 receives request 190 from clients 115 and transmits response 195 to clients 115.

In some embodiments, input device 170 may refer to any suitable device operable to input, select, and/or manipulate various data and information. Input device 170 may include, for example, a keyboard, mouse, graphics tablet, joystick, light pen, microphone, scanner, or other suitable input device. Output device 175 may refer to any suitable device operable for displaying information to a user. Output device 175 may include, for example, a video display, a printer, a plotter, or other suitable output device.

In general, operator 150 may interact with server 140 using an operator workstation 145. In some embodiments, operator workstation 145 may be communicatively coupled to server 140 and may refer to any suitable computing system, workstation, personal computer such as a laptop, or any other device operable to process data. In certain embodiments, an operator 150 may utilize operator workstation 145 to manage server 140 and any of the data stored in server memory 160 and/or network storage device 125.

In operation, application 162, upon execution by processor 155, facilitates displaying a giving plan. For example, application 162 receives a request to display a giving plan associated with donor 135. A request may be initiated by donor 135 (or a user that donor 135 authorizes to initiate requests on his or her behalf, such as donor 135's estate planner). Application 162 determines beneficiaries and assets of donor 135. Application 162 also determines an allocation plan that associates one or more of the assets with one or more of the beneficiaries. Application 162 may then display the requested giving plan. The giving plan may comprise a graphical representation of the beneficiaries. The graphical representation may show a relative value of the assets associated with each beneficiary based on the allocation plan. The giving plan may also comprise interactive features that allow donor 135 to modify the graphical representation in order to visualize a potential change to the allocation plan.

Although the preceding example describes that processor(s) associated with server 140 execute application 162, in alternate embodiments application 162 may be configured to be executed at client 115 (independently of server 140).

FIGS. 2A and 2B illustrate an example of information communicated by application 162. In some embodiments, application 162 communicates display 200. Display 200 may be operable to display a profile 202, a giving plan 250, and/or any suitable portions of the preceding. Profile 202 includes configuration options for designing a giving plan 250 that distributes donor 135's assets among beneficiaries of donor 135. Thus, giving plan 250 shows how assets would be distributed to beneficiaries of donor 135 if profile 202 was implemented. As donor 135 makes changes to profile 202, giving plan 250 may be updated to show the effect of those changes. Accordingly, donor 135 may be able to better understand how to design giving plan 250 in order to distribute assets to the beneficiaries according to donor 135's wishes.

In some embodiments, donor 135 may set up multiple profiles 202, and each profile may be associated with a corresponding giving plan 250. For example, a first profile 202a may be associated with a first giving plan 250a, and a second profile 202b may be associated with a second giving plan 250b. Donor 135 may compare giving plan 250a and giving plan 250b to determine which alternative donor 135 prefers. In some embodiments, donor 135 may set a priority indicator for profile 202. The priority indicator allows donor 135 to indicate how well a profile 202 meets donor 135's preferences relative to the other profiles 202. As an example, the priority indicator may allow donor 135 to prioritize profiles 202 in sequential order or according to a tier system. In some embodiments, donor 135 may designate one of the profiles 202 to implement. Prioritizing profiles 202 may help donor 135 facilitate a conversation with an estate planner, trust advisor, title company, attorney, accountant, bank, or other advisor advising donor 135 with respect to implementing the giving plan.

FIG. 2A illustrates an example of profile 202. Profile 202 may include a beneficiary list 204, an asset list 220, an allocation plan 238, and/or other suitable configuration options. In some embodiments, beneficiary list 204 indicates potential beneficiaries of donor 135, asset list 220 indicates assets of donor 135 that may be distributed according to giving plan 250, and allocation plan 238 associates one or more beneficiaries with one or more of the assets.

Beneficiary list 204 may include any suitable options such as an add beneficiary option 206, an import family tree option 214, a delete beneficiary option 216, and/or a modify beneficiary option 218. The add beneficiary option 206 may allow donor 135 to input information about the beneficiary, such as name 208, contact information 210, and/or relationship 212. Name 208 may include a first name, last, name, middle name, and/or any other information for identifying the beneficiary (social security number, driver's license number, birth date, and so on). Contact information 210 may include one or more phone numbers, email addresses, street addresses, or other information for contacting the beneficiary. Relationship 212 may indicate donor 135's relationship to the beneficiary. Examples of relationships may include, but are not limited to, parent, spouse, child, stepchild, grandchild, sibling, half-sibling, in-law, other relative, friend, charity, and so on.

The import family tree option 214 may allow donor 135 to efficiently add a number of beneficiaries. In some embodiments, genealogical software may generate a tree structure indicating names of donor 135's family members and each family member's relationship to donor 135. The tree structure may be stored in a file, a database, a webpage, or other suitable format. The import family tree option 214 may retrieve the tree structure so that donor 135 does not have to enter members of the family tree into profile 202 one-by-one. In some embodiments, the import family tree option 214 may allow for filtering the import functionality based on the family member's relationship to donor 135. As an example, the import function may import family members that are related to donor 135 by n or fewer degrees without importing family members that are related to donor by greater than n degrees. In one embodiment, n could be configured to include donor 135's fourth degree relatives (e.g., first cousins and closer family members), but exclude donor 135's fifth degree relatives (e.g., second cousins and more distant family members). The value of n may be pre-configured to a default value and/or dynamically configured by donor 135.

The delete beneficiary option 216 allows donor 135 to remove beneficiaries. The modify beneficiary option 218 allows donor 135 to edit any of the information associated with a beneficiary. Name 208 may be updated to reflect a name change, for example, if the beneficiary gets married or otherwise changes names. Contact information 210 may be updated to reflect a new phone number, an address change, or other change to the beneficiary's contact information. Relationship 212 may be updated to reflect a change in the relationship. For example, donor 135 may change a relationship from stepchild to child in the event of an adoption.

Asset list 220 allows for identifying assets of donor 135 that may be distributed to donor 135's beneficiaries. Asset list 220 may include any suitable options such as an add asset option 222, a link to account option 232, a delete asset option 234, and/or a modify asset option 236.

Donor 135 may initiate add asset option 222 in any suitable manner, such as selecting from a menu in profile 202 or by uploading a photograph of the asset to application 162. The add asset option 222 may allow donor 135 to input information about an asset, such as asset identifier 224, asset description 226, asset value 228, and tag configuration 230. Asset identifier 224 may be any suitable identifier, such as a numeric value, a name of the asset (e.g., car, house, bank account X, family heirloom, and so on), or a combination. Asset description 226 may include additional details about the asset, such as a detailed description of the asset (e.g., written description and/or photograph of the asset), information for locating and/or accessing the asset, or other details. Asset value 228 may indicate a monetary value associated with the asset.

Tag configuration 230 may allow donor 135 to designate one or more beneficiaries to own the asset. As an example, donor 135 may designate all of donor 135's children to jointly inherit a house in equal shares. In some embodiments, each tag configuration 230 may include an option indicating whether the details of a corresponding tag 258 should be shown or hidden in giving plan 250. For example, donor 135 may opt to show personal items (heirloom, family photo, and so on) to help donor 135 allocate these items fairly. Accordingly, giving plan 250 may display an icon, photograph, item name, and/or specific monetary value for each asset that donor 135 opts to show. Donor 135 may opt to hide the details of fungible (non-personal) items, such as financial accounts, that donor 135 intends to allocate based on monetary value, rather than sentimental value, because the details might not be useful in helping donor 135 make an allocation decision for such assets. Thus, giving plan 250 would not display an icon, photograph, item name, and/or specific monetary value for each asset that donor 135 opts to hide. Giving plan 250 may display the total monetary value of assets allocated per beneficiary. The total monetary value includes the value of the assets for which donor 135 opts to show the details (e.g., family heirlooms) plus the assets for which donor 135 opts to hide the details (e.g., financial accounts).

Link to account option 232 may allow donor 135 to add and/or modify one or more assets. In some embodiments, link to account option 232 may prompt donor 135 to log into one or more online banking accounts of donor 135. Link to account option 232 may then automatically retrieve account information for one or more of donor 135's financial accounts. Examples of financial accounts include a checking account, a savings account, an investment account, or other account(s) associated with donor 135's online banking account. The account information retrieved by link to account option 232 may be used to automatically populate (or update) identifier 224, asset description 226, and/or asset value 228. In some embodiments, link to account option 232 may also populate tag configuration 230 if the asset has already been allocated to a particular beneficiary. For example, if by contract donor 135's retirement account must go to donor 135's spouse, then tag configuration 230 may be automatically updated to correlate the retirement account with the spouse. Although the preceding example has been described with respect to an online banking account, in certain embodiments link to account option 232 may allow for automatically importing asset information from one or more databases, documents, spreadsheets, webpages, and/or other suitable sources.

Delete asset option 234 allows an asset to be deleted, for example, if donor 135 sells the asset or no longer wishes to make a gift of the asset. Modify asset option 236 allows an asset to be modified. For example, donor 135 may increase or decrease asset value 228 depending on whether the asset appreciates or depreciates over time. Or donor 135 may add or remove detail in asset description 226.

Allocation plan 238 allows donor 135 to set up one or more rules to associate a beneficiary with an asset. Allocation plan 238 may provide any suitable options for allocating assets. In some embodiments, allocation plan 238 prompts donor 135 to answer a set of simple questions and generates the rules according to donor 135's responses. The simple questions may be in plain language and free of legal jargon such as “per capita” and “per stirpes.” Thus, allocation plan 238 may simplify donor 135's decision-making by making the process more understandable.

In some embodiments, allocation plan 238 may allocate assets by name 240, by relationship 242, and/or by contingency 244. To allocate by name 240, donor 135 may select the name of a beneficiary and associate the name with a particular asset or portion of an asset, such as x % of a financial account. To allocate by relationship 242, donor may select a relationship and associate the relationship with an asset. For example, donor 135 may choose to allocate an investment account evenly among all of donor 135's grandchildren. In some embodiments, tag configuration 230 associated with an asset may be updated to reflect how the asset has been allocated. Indicators may be used to assist donor 135 in keeping track of assets that have not yet been allocated.

Contingency 244 allows donor 135 to select events that could potentially happen in the future and to determine how the assets would be allocated if the event happened. For example, donor 135 may wish to plan a will for making testamentary gifts. Donor 135's will may allocate asset A to beneficiary A. Contingency 244 may allow donor to see how asset A would be allocated in the even that beneficiary A pre-deceases donor 135. Donor 135 may adjust allocation plan 238 to address such contingencies.

In some embodiments, application 162 generates and/or updates profile 202 by prompting donor 135 to enter information or providing menus by which donor 135 may enter information. In some embodiments, application 162 generates and/or updates profile 202 automatically based on donor 135's interactions with a graphical representation of giving plan 250 discussed below. Accordingly, application 162 may or may not display profile 202 to donor 135 depending on how application 162 is configured to generate profile 202.

FIG. 2B illustrates an example of giving plan 250. Giving plan 250 may comprise any suitable image, simulation, animation, and/or other graphical representation based on allocation plan 238. As an example, the graphical representation may show beneficiaries of donor 135 and a relative value of the assets associated with each beneficiary according to allocation plan 238. In some embodiments, donor 135 may have the option of selecting a format for giving plan 250 from a number of alternatives. As an example, donor 135 may choose a waterfall simulation, a seesaw simulation, a balance scale, a bar graph, a pie chart, a tree structure, a photo album simulation, or any other format based on donor 135's preferences.

In the example, FIG. 2B illustrates a tree structure. The tree comprises a donor node 252 representing donor 135 and beneficiary nodes 254 representing the beneficiaries configured in profile 202. The tree may be organized to visualize the relationship between donor 135 and the beneficiaries. For example, beneficiary nodes 254a and 254b representing donor 135's children A and B, respectively, may each be connected directly beneath donor node 252. Beneficiary nodes 254c and 254d representing child A's children (grandchild A1 and A2, respectively) may each be connected directly beneath beneficiary node 254a. Similarly, beneficiary node 254e representing child B's child (grandchild B) may be connected directly beneath beneficiary node 254b. Beneficiary node 254n may represent a charity X that donor 135 supports. Accordingly, beneficiary node 254n may be indirectly connected to donor node 252 as shown by the dashed line in the example.

In some embodiments, giving plan 250 may comprise a visual indicator 256 associated with each beneficiary. Visual indicator 256 may help donor 135 understand the relative monetary value of the assets allocated to one beneficiary as compared to the monetary value of the assets allocated to another beneficiary. As an example, visual indicator 256 may comprise a container, such as a bucket. As the total value of the assets allocated to a beneficiary increase, the corresponding bucket may become more full. Donor 135 may opt to adjust allocation plan 238 if donor 135 believes the current plan is unfair (e.g., one of the buckets is too full or too empty). In certain embodiments, visual indicator 256 may comprise a numeric score, a percentage of the total value of the allocated assets, a total dollar value allocated per beneficiary, a color code, a size, a shape, a pointer, a gauge, or other suitable indicator. In certain embodiments, one of the visual indicators may correspond to donor 135 in order to depict the value of any assets that have not been allocated to beneficiaries.

Giving plan 250 may optionally display one or more tags 258. In some embodiments, tag 258 may correspond to one of the tag configurations 230 that profile 202 is configured to show (as discussed with respect to FIG. 2A above, in some embodiments, each tag configuration 230 may be configured in profile 202 to show or hide a corresponding tag 258). Tag 258 may comprise an icon, photograph, item name, and/or specific monetary value for the asset. Tag 258 may be positioned proximate (e.g., visually linked) to a corresponding beneficiary in any suitable manner. As an example, a line may connect tag 258 to a corresponding beneficiary node 254. As another example, tag 258 may be located near or inside a boundary that defines the corresponding beneficiary node 254. In some embodiments, donor 135 may use tags 258 to show personal items (heirloom, family photo, and so on) in order to help donor 135 allocate these items fairly among beneficiaries.

Giving plan 250 may include interactive features 260 to facilitate modifying the graphical representation so that donor 135 can visualize potential changes to allocation plan 238. Donor 135 may try out a number of different allocation options within the visual context of giving plan 250. As an example, one interactive feature 260 could allow donor 135 to fill buckets associated with the beneficiaries. As another example, one interactive feature 260 could allow donor 135 to make changes that tip a balance scale or seesaw. Seeing the change may help donor 135 to make a better decision about which option donor 135 prefers.

In addition, interactive features 260 may make trying out the different options somewhat game-like to reduce the emotional hardship of making allocation decisions. In some embodiments, interactive features 260 may allow for testing contingencies 244 such that donor 135 may visualize how assets would flow if something were to happen to a beneficiary, several beneficiaries, or a generation of beneficiaries, such as the generation comprising the children of donor 135. Examples of interactive 258 features include drag-and-drop capability, flip switches, adjustable slides or scales, filters, and so on. In some embodiments, allocation plan 238 of profile 202 may be updated, either automatically or in response to a user instruction, in order to reflect the modifications made to the graphical representation using interactive features 260.

In some embodiments, giving plan 250 may be configured to show the allocation of assets over an interval of time. As an example, donor 135 may wish to make periodic living gifts to the beneficiaries. Donor 135 may schedule gifts to be made on date X, on a later date Y, and an even later date Z. Giving plan 250 may display the distribution of the assets as of a particular date selected by the user. For example, if donor 135 selects to view date Z, giving plan 250 may display the assets distributed to particular beneficiaries on date Z and/or the total of the assets distributed to those beneficiaries over time as of date Z (i.e., the sum of the gifts distributed on earlier dates X and Y plus the gifts distributed on date Z). Donor 135 may click through the distribution of assets one date at a time and/or donor 135 may view a the distribution of assets for multiple dates simultaneously, for example, a timeline may display multiple dates on the same screen at the same time.

In some embodiments, donor 135 may select to view gifts allocated to a particular beneficiary over time. FIG. 2C illustrates an example view of giving plan 250b that displays progress toward a financial goal associated with the beneficiary. Donor 135 and/or the beneficiary may contribute funds toward the goal. Accordingly, giving plan 250b may include checkboxes 402 and 404 to show contributions from donor 135 and/or the beneficiary. When checkbox 402 is selected, giving plan 250b displays donor 135's contributions. When checkbox 404 is selected, giving plan 250b displays the beneficiary's contributions. In certain embodiments, one of checkbox 402 and checkbox 404 may be disabled to disallow a user (e.g., beneficiary and/or donor 135) from seeing contributions from another user. In particular embodiments, such as that shown in giving plan 250b, the beneficiary's contributions are made generally at any time while donor 135's contributions are made annually. In this example, donor 135's contributions are capped at $13,000. This amount may be equal to a tax-free giving limit, such that gifting from an older individual to a future heir is maximized under the applicable tax code. At the end of 2012, the transferor's contributions are less than the maximum because the difference between the monetary target and the amount of savings at that time is less than the maximum contribution of $13,000.

FIG. 3 illustrates an example of a method 300 for displaying giving plan 250. The method begins at step 304 where application 162 receives a request to display giving plan 250 associated with donor 135. At step 308, application 162 determines a plurality of beneficiaries of donor 135. To determine the beneficiaries, application 162 may retrieve an existing profile 202 that application 162 associates with donor 135, or application 162 may generate a new profile 202 based on input from donor 135. For example, application 162 may provide a prompt or menu for donor 135 to enter information about a beneficiary, such as the beneficiary's name and relationship to donor 135. In some embodiments, application 162 may provide a prompt or menu for donor 135 to input a URL or other filepath for donor 135's family tree and login credentials for accessing the family tree, if needed. Application 162 may import family members from the family tree as potential beneficiaries of donor 135.

Application 162 determines assets of donor 135 at step 312. As an example, application 162 may provide a prompt or menu for donor 135 to enter information about an asset, such as an identifier and a monetary value of the asset. In some embodiments, application 162 may prompt donor 135 to enter an asset in response to receiving a photograph of the asset. In some embodiments, application 162 may provide a prompt or menu for donor 135 to link to an account, such as an online banking account associated with donor 135. Donor 135 may enter a URL or other filepath for the account and any login credentials required for application 162 to access the account and retrieve information.

Application 162 may determine any tag configurations 230 associated with an asset. Tag configuration 230 may indicate one or more beneficiaries for the asset. In some embodiments, tag configuration 230 may indicate whether to show or hide details of the asset in a graphical representation of giving plan 250. For example, donor 135 may choose to show photographs of certain personal items (jewelry, art, vehicles, real estate, furniture, or other personal items) in the graphical representation to help donor 135 distribute the personal items fairly. Donor 135 may choose not to show details of non-personal items (such as financial accounts) for which the monetary value provides sufficient information for donor 135 to make an allocation decision. In some embodiments application 162 may apply default settings associated with tag configuration 230. As an example, in some embodiments, the default settings may automatically show tags 258 associated with certain categories (e.g., categories of personal items) and hide tags 258 associated with other categories (e.g., categories of financial accounts). As another example, the default settings may show the tags 258 for which a photograph is available and hide the tags 258 for which a photograph is not available. In some embodiments, donor 135 may change tag configuration 230 from the default settings to customized settings.

At step 316, application 162 determines an allocation plan 238 for associating one or more of the assets with one or more of the beneficiaries. Allocations may be made by selecting an asset and assigning it to one or more beneficiaries and/or by selecting a beneficiary and assigning the beneficiary to one or more assets. In some embodiments, application 162 may prompt donor 135 to answer simple, plain language questions, and donor 135's responses may be used to generate allocation plan 238. In some embodiments, application 162 may determine a relationship between donor 135 and one or more of the beneficiaries and associate assets with the beneficiaries according to the relationship. As an example, application 162 may determine to associate a financial account with donor 135's grandchildren such that each grandchild gets an equal share of the financial account.

Application 162 valuates the assets per beneficiary at step 320. For each beneficiary, application 162 may determine all of the assets (or portions of assets) associated with the beneficiary. Application 162 may sum the monetary values of the beneficiary's share of those assets. The monetary value may be used to determine the beneficiary's share of the total assets. In some embodiments, further valuations may be performed according to a category. Any suitable categories may be used. For example, application 162 may determine that an allocation plan associates a particular beneficiary with $X in family heirlooms, $Y in real estate, and $Z in financial accounts.

The method proceeds to step 324 where application 162 displays giving plan 250. Giving plan 250 may comprise a graphical representation of the beneficiaries and a relative value of the assets associated with each beneficiary based on the allocation plan. For example, the valuation determined in step 320 may be used to select a numeric score, a percentage of the total value of the allocated assets, a total dollar value allocated per beneficiary, a color code, a size, a shape, a pointer, a gauge, or other suitable indicator of the beneficiary's share of the assets. The graphical representation may display tags 258 associated with certain assets, such as personal items, proximate to the beneficiary associated with the personal item. The tag may comprise a description of the personal item, a monetary value associated with the personal item, a photograph of the personal item, and/or other suitable details.

Giving plan 250 may also comprise one or more interactive features 260 operable to facilitate modifying the graphical representation. Modifying the graphical representation may help donor 135 visualize potential changes to allocation plan 238 in order to perform contingency planning or to evaluate alternative allocation plans 238. As an example, one interactive feature 260 may allow donor 135 to drag a family heirloom tagged to a first child and drop the family heirloom to change the tag to a second child. Donor 135 may opt to do this if the graphical display shows that the first child had been associated with a disproportionate number of family heirlooms.

At step 328, application 162 saves modifications. In some embodiments, application 162 may allow donor 135 to create a number of alternative giving plans 250. Application 162 may display a comparison between a first giving plan 250a and a second giving plan 250b to help donor 135 prioritize the giving plans 250. The comparison may be a side-by-side view of the giving plans 250, a summary of the differences between the giving plans 250, a list of beneficiaries that benefit more from one giving plan 250 as compared to the other giving plan 250, or other suitable comparison. The method then ends.

Modifications, additions, or omissions may be made to the systems described herein without departing from the scope of the invention. The components may be integrated or separated. Moreover, the operations may be performed by more, fewer, or other components. Additionally, the operations may be performed using any suitable logic comprising software, hardware, and/or other logic. As used in this document, “each” refers to each member of a set or each member of a subset of a set. A subset may include zero, one, or more members.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described in detail, it should be understood that various changes, substitutions, and alterations can be made hereto without departing from the scope of the invention as defined by the appended claims.

1. A system, comprising:
an interface operable to:
receive a request to display a giving plan associated with a donor; and
one or more processors communicatively coupled to the interface and operable to:
determine a plurality of beneficiaries of the donor;
determine a plurality of assets of the donor; and
determine an allocation plan, the allocation plan associating one or more of the assets with one or more of the beneficiaries;
the interface further operable to:
display the giving plan, the giving plan comprising:
a graphical representation of the beneficiaries and a plurality of visual indicators, each visual indicator comprising a color, shape, or size that indicates a relative value of the assets associated with each beneficiary based on the allocation plan; and
one or more interactive features operable to facilitate modifying the appearance of the visual indicators in the graphical representation in order to visualize a potential change to the allocation plan.

2. The system of claim 1, wherein the one or more processors operable to determine the plurality of beneficiaries comprises importing a family tree.

3. The system of claim 1, wherein the one or more processors operable to determine the plurality of assets comprises:
linking to an account associated with the donor; and
retrieving information corresponding to one of the assets.

4. The system of claim 1, wherein the graphical representation displays a photograph of a particular one of the assets proximate to the beneficiary associated with the particular one of the assets.

5. The system of claim 1, wherein one of the assets comprises a personal item and the graphical representation displays a tag proximate to the beneficiary associated with the personal item, the tag comprising a description of the personal item and a monetary value associated with the personal item.

6. The system of claim 1, wherein the one or more processors operable to determine the allocation plan comprises:
determining a relationship between the donor and one or more of the beneficiaries; and
associating the one or more of the assets with the one or more of the beneficiaries according to the relationship.

7. The system of claim 1, the interface further operable to display a comparison between the giving plan and a second giving plan.

8. The system of claim 1, the interface further operable to display a first subset of assets associated with one of the beneficiaries as of a first date and a second subset of assets associated with the one of the beneficiaries as of a second date.

9. A non-transitory computer readable storage medium comprising logic, the logic, when executed by a processor, operable to:
receive a request to display a giving plan associated with a donor;
determine a plurality of beneficiaries of the donor;
determine a plurality of assets of the donor;
determine an allocation plan, the allocation plan associating one or more of the assets with one or more of the beneficiaries; and
display the giving plan, the giving plan comprising:
a graphical representation of the beneficiaries and a plurality of visual indicators, each visual indicator comprising a color, shape, or size that indicates a relative value of the assets associated with each beneficiary based on the allocation plan; and
one or more interactive features operable to facilitate modifying the appearance of the visual indicators in the graphical representation in order to visualize a potential change to the allocation plan.

10. The medium of claim 9, wherein the logic operable to determine the plurality of beneficiaries comprises importing a family tree.

11. The medium claim 9, wherein the logic operable to determine the plurality of assets comprises:
linking to an account associated with the donor; and
retrieving information corresponding to one of the assets.

12. The medium of claim 9, wherein the graphical representation displays a photograph of a particular one of the assets proximate to the beneficiary associated with the particular one of the assets.

13. The medium of claim 9, wherein one of the assets comprises a personal item and the graphical representation displays a tag proximate to the beneficiary associated with the personal item, the tag comprising a description of the personal item and a monetary value associated with the personal item.

14. The medium of claim 9, wherein the logic operable to determine the allocation plan comprises:
determining a relationship between the donor and one or more of the beneficiaries; and
associating the one or more of the assets with the one or more of the beneficiaries according to the relationship.

15. The medium of claim 9, the logic further operable to display a comparison between the giving plan and a second giving plan.

16. The medium of claim 15, the logic further operable to display a first subset of assets associated with one of the beneficiaries as of a first date and a second subset of assets associated with the one of the beneficiaries as of a second date.

17. A method, comprising:
receiving a request to display a giving plan associated with a donor;
determining a plurality of beneficiaries of the donor;
determining a plurality of assets of the donor;
determining, by a processor, an allocation plan, the allocation plan associating one or more of the assets with one or more of the beneficiaries; and
displaying the giving plan, the giving plan comprising:
a graphical representation of the beneficiaries and a plurality of visual indicators, each visual indicator comprising a color, shape, or size that indicates a relative value of the assets associated with each beneficiary based on the allocation plan; and
one or more interactive features operable to facilitate modifying the appearance of the visual indicators in the graphical representation in order to visualize a potential change to the allocation plan.

18. The method of claim 17, wherein determining the plurality of beneficiaries comprises importing a family tree.

19. The method claim 17, wherein determining the plurality of assets comprises:
linking to an account associated with the donor; and
retrieving information corresponding to one of the assets.

20. The method of claim 17, wherein the graphical representation displays a photograph of a particular one of the assets proximate to the beneficiary associated with the particular one of the assets.
